(19) United States
(12) Patent Application Publication
(10) Pub. No.: US 2024/0148001 A1
(43) Pub. Date: May 9, 2024

(54) DISINFECTANT COMPOSITION FOR INFUSION INTO POROUS SURFACES AND THE METHOD OF PREPARATION THEREOF

(71) Applicant: Prerna Goradia, Mumbai (IN)

(72) Inventor: Prerna Goradia, Mumbai (IN)

(21) Appl. No.: 18/413,411

(22) Filed: Jan. 16, 2024

Related U.S. Application Data
(63) Continuation of application No. PCT/IN2022/050614, filed on Jul. 5, 2022.

(30) Foreign Application Priority Data
Jul. 5, 2021 (IN) 202121030029

(51) Int. Cl. A01N 59/16; A01N 25/12; A01P 1/00

(52) U.S. Cl. CPC A01N 59/16; A01N 25/12; A01P 1/00

(57) ABSTRACT

The present invention relates to non-cytotoxic disinfectant and sanitizer composition for disinfecting porous surfaces such as textiles, wood, paints, ceramics, PPE's etc. and method of preparing the same. The composition comprises of anti-microbial ceramic compounds, photo catalytic agents selected from the group consisting of titania, zinc oxide, magnesium oxide and silica; at least one surfactants and excipients. The composition can effectively neutralize microorganisms deep into the surfaces while not altering the characteristics of the articles. The compositions are designed to impart negative ion effect, cooling effect, help to remove toxic gases from the environment and yield long lasting effects by binding to the articles. Besides, as part of air and water filters, the additive aids in the removal of volatile organic compounds (VOCs); thereby providing great potential applications for contaminant control in indoor environments such as residences, office buildings, factories.

### RELATED APPLICATIONS

This application claims priority under 35 U.S.C. § 120 to, and is a continuation of, co-pending International Application PCT/IN2022/050614, filed Jul. 5, 2022 and designating the US, which claims priority to IN Application 202121030029, filed Jul. 5, 2021, such IN Application also being claimed priority to under 35 U.S.C. § 119. These IN and International applications are incorporated by reference herein in their entireties.

### FIELD

The present invention relates to a disinfectant and specialty additive composition and its preparation. Particularly, the present invention relates to a disinfectant and sanitizer composition for porous materials and coatings comprising non toxic and skin friendly anti-microbial and photo catalytic agents. Besides, as part of air and water filters the additive aids in the removal of organic pollutants in the gaseous or dissolved phase. The invention further relates to combination of different photocatalysts and the methods of synthesis, the end result yielding a very powerful and clean porous formulation which is effective against microbes and virus families including the respiratory system viruses.

### BACKGROUND

Textiles are used in a variety of environments such as hospitals, offices, home, hotel, industrial premises and for varied purposes and there are huge chances of microbiological contamination on the articles because of staining, spillage, moisture and humidity. Microbiological growth on textiles is a serious concern as the surfaces being porous may harbor the growth of microbes. Military personnel at times have to wear the same clothing for more than one day; while in the hospitals this might lead to severe infections.

Besides textiles, there is also a need for safe and efficient disinfectants for other non-human surfaces such as paints, wood, polymer surface and other porous surfaces. Porous materials like items made of fabrics or wood do not repel liquids and may, in fact, absorb moisture. Many of these items can be laundered, such as removable seat covers, curtains, drapes, etc. but many others cannot be laundered (mattresses, box springs, couches, rugs, upholstered chairs and benches, etc.).

Accordingly, it is desired to develop an efficient formulation, which enables the treatment of surfaces with potent anti-microbial compound, which can effectively prevent the spread of the virus. Though a few metal derivatives containing anti microbials are available, but there are shortcomings such as poor durability of antimicrobial activity, poor heat resistance, toxicity, and narrow range of application. Thus, there is need of a formulation which is single component and does not require any external binder.

References have been made to the following literature:
Research publication by Chunhong Zhu discusses about the self-cleaning cotton fabrics, fabricated by coating photocatalytic zinc oxide nanoparticles (ZnO NPs) on cotton surfaces, using a traditional dip-pad-dry-cure coating process. Results of wash fastness showed color removal after 10 times washing under light irradiation and, the ZnO NP-coated fabrics exhibited excellent ultraviolet blocking properties. The present invention although contains ZnO like the prior art it does so in conjunction with several other constituents which add to the overall potency of the composition. Besides, the present invention is a nanoparticle free composition, because of the toxicity issues associated with the NPs.
U.S. Ser. No. 10/542,756 relates to a method of treating a textile substrate by applying a disinfecting treating composition comprising at least one anti-microbial agent, using an exhaust process, and subjecting the textile substrate to one or more heat treatments. The prior art relates to a method of treatment of textiles using quaternary ammonium salts, which could be toxic compounds and the method as well is very different from the present invention.
CN1538002A relates to textile containing photocatalytic bacterialcide and its preparation method. The invention belongs to fabric containing photochemical catalyst comprising titania photo catalyst, doped with the titanium oxide catalyst of iron ion, titanium oxide and zinc oxide composite catalyst or titanium oxide and silica composite catalyst. The composition and the method of preparation of the present invention is different from the prior art as it comprises the novel combination of silver and metal oxides dispersed in surfactants with higher critical aggregation concentrations, besides a unique easy curing polymer system.
U.S. Pat. No. 8,425,880B1 relates to metal-containing materials, as well as formulations and uses thereof. The disclosure features a method including contacting an area of a subject having bacterial spores with one or more silver-containing materials to kill the bacterial spores.
CA2656332A1 relates to metal-containing materials, as well as formulations and uses thereof. Many different formulations have been developed to treat undesirable conditions. For example, certain forms of silver have been reported to be effective in treating some undesirable skin conditions. The disclosure features a composition including a pharmaceutically acceptable carrier, from 0.1 to five percent by weight of a metal-containing material in the pharmaceutically acceptable carrier, and from two to 20 percent by weight stearic acid in the pharmaceutically acceptable carrier.

The information disclosed in this background of the disclosure section is only for enhancement of understanding of the general background of the invention and should not be taken as an acknowledgement or any form of suggestion that this information forms the prior art already known to a person skilled in the art.

### SUMMARY

The principle object of the present invention to provide a disinfectant composition containing unique photo catalytic anti-microbial agents, which can be applied on textiles & various surfaces including plastic, rubber, card-board, wood and other porous surfaces.

It is evident that despite the widespread use of silver for its anti microbial property, they have a limited durability and activity. The present invention relates to provide a stable photo catalytic disinfectant additive composition with broad spectrum activity against pathogens and low toxicity in porous substrates. Besides, the methodology involved in the present invention is a unique and a scalable solution. The stable additive besides usable in the industry by being added in the padding step in the textiles, can be used for house laundry as well as professional laundry settings. Further, it fixes effectively on fibers simply by drying and additional curing is not mandatory. This in turn provides a cost efficient solution and prolonged protection against pathogens. It also has several other properties such as cooling properties and water softeners to work and lather in hard water. It can be mixed into paints and concrete mixes effectively and safely.

The present invention attempts to overcome the problems faced in the prior art, and discloses a photo catalytic disinfectant composition which can effectively neutralize microorganisms from the surfaces while not altering the characteristics of the articles. Besides, as part of air and water filters the additive aids in the removal of volatile organic compounds (VOCs), thereby having great potential applications to contaminant control in indoor environments such as residences, office buildings, factories.

The present invention discloses a non cytotoxic disinfectant composition for disinfecting the porous surfaces such as textiles, wood, gloves etc. and method of preparing the same. The composition comprises of anti-microbial ceramic compounds; photocatalytic agents selected from the group consisting of titania, silica; surfactants and excipients.

In accordance with the embodiment of the present invention, the invention discloses an aqueous disinfectant and sanitizer composition for porous substrates comprising: at least one anti-microbial ceramic compound 0% to 5% (wt/v); carrier particles 0% to 30% (wt/v); binder polymer compounds 1% to 5% (wt/v); and excipient mix 0.1 to 50% (wt/v), further the excipient mix consists of a combination of cationic and anionic detergents.

In accordance with the embodiment of the present invention, the invention discloses a composition containing at least one anti-microbial ceramic compound, selected from a group comprising of silver containing compounds, copper containing compounds, zinc containing compounds, platinum containing compounds, palladium containing compounds, magnesium containing compounds, molybdenum containing compounds and combinations thereof. Further, at least one carrier particle, selected from a group of photocatalytic agents comprising of titanium compounds, zinc oxide, silica, and combinations thereof. Besides, the carrier particles provide the matrix for the anti-microbial compounds.

In accordance with the embodiment of the present invention, the invention discloses a composition where at least one polymer is selected from a group comprising Polyacrylamide, poly(acrylamide-co-acrylic acid), Poly(vinyl alcohol) (PVA), poly vinyl pyrrolidone (PVP), carboxy methyl cellulose (CMC) and polyethylene oxide (PEO), acrylates and combinations thereof. In another embodiment, at least one excipient is selected from a group comprising strong ionic detergents such as cetyltrimethylammonium bromide or chloride, sodium salt of cholic acid, sodium salt of deoxycholic acid, sodium salt of dioctyl sulfosuccinate, sodium salt of dodecyl sulphate and sodium salt of N-lauroylsarcosine and sodium lauryl ether sulphate (SLES) and combinations thereof.

In accordance with the embodiment of the present invention, the invention discloses a method for producing disinfectant/sanitizer composition for porous substrates comprising the steps of mixing 0% to 5% (wt/v) of at least one or mixture of antimicrobial ceramic compound selected from a group comprising compounds of silver, copper, zinc and combinations thereof with 0% to 30% (wt/v) of at least one carrier particle. Further, the powders are grinded into a fine mixture, followed by adding measured volume of water to the powder mix. This is followed by adding 1% to 5% (wt/v) bio polymer to the solution and further, adding at least one of the excipients followed by a second one in a ratio of almost 30 to 50% of the final composition. The final volume is made up with water.

In accordance with the embodiment of the present invention, at least one carrier particle for supporting the antimicrobial metal compound on the surface of the carrier particle is selected from a group consisting of hydrous titanium oxide, titanium oxide, zinc oxide, silica and zeolites such as zeolites (microporous, aluminosilicate minerals), molecular sieves, and combinations thereof, but not limited to. Further, the molecular sieves are good for absorbing gases.

In accordance with the embodiment of the present invention, the antimicrobial compound and the carrier salts are finely ground in an industrial grinder to ensure that the particle size is in the low micron range of −100 microns. In another embodiment, the excipient mix is a combination of cationic and anionic detergents in the ratio of 2:3 to 4:7. Further, when incorporated into the composition the excipient mix attenuates the suspension to a viscous and homogeneous solution which is very stable. Further, the composition is in the form of a tablet or capsule containing the antimicrobial powder, or antimicrobial solutions in the form as aerosols, infusions, spray formulation, powder or powder spray, mist, drops, or one or more liquid formulations or spray dried to generate a powdered form, and combinations thereof, where the cold spraying or spray drying technique is used for making powder formulation.

In accordance with the embodiment of the present invention, the combination of photocatalytic agents with these transition metals results in a synergistic antimicrobial action, very important for providing the distinct property to the porous materials.

The present invention further discloses a photocatalytic disinfectant composition, which besides non toxic and skin friendly, prohibits the growth of microorganisms, removes volatile organic compounds (VOCs) and prevents unpleasant odors.

The foregoing summary is illustrative only and is not intended to be in any way limiting. In addition to the illustrative aspects, embodiments, and features described above, further aspects, embodiments, and features will become apparent by reference to the drawings and the following detailed description.

### DETAILED DESCRIPTION

While the embodiments of the disclosure are subject to various modifications and alternative forms, specific embodiments thereof have been shown by way of example in the figures and will be described below. It should be understood, however, that it is not intended to limit the disclosure to the particular forms disclosed, but on the contrary, the disclosure is intended to cover all modifications, equivalents, and alternatives falling within the scope of the disclosure. Further, the phraseology and terminology employed in the description is for the purpose of description only and not for the purpose of limitation.

The terms “comprises”, “comprising”, or any other variations thereof used in the disclosure, are intended to cover a non-exclusive inclusion, such that a device, apparatus, system, assembly, method that comprises a list of components or a series of steps that does not include only those components or steps but may include other components or steps not expressly listed or inherent to such apparatus, or assembly, or device. In other words, one or more elements or steps in a system or device or process proceeded by “comprises . . . a” or “comprising . . . of” does not, without more constraints, preclude the existence of other elements or additional elements or additional steps in the system or device or process as the case may be.

The primary object of the present invention is to provide any porous surface or substrate disinfecting composition providing antibacterial, antiviral, antifungal and wash durable properties.

In accordance with the embodiments of the present invention, the invention relates to a non cytotoxic disinfectant composition for disinfecting the porous surfaces such as textiles, wood, PPE etc. and method of preparing the same. The composition comprises of anti microbial metal compounds, photocatyltic agents selected from the group consisting of titania, silica, surfactants and excipients. The composition can effectively neutralize microorganisms from the surfaces while not altering the characteristics of the articles.

Silver is currently approved for use in numerous medical applications. It is a naturally occurring ‘green’ material that has been used for thousands of years for its antimicrobial properties. The controlled synthesis of stable silver complexes that do not undergo surface oxidation at the same time offering a controlled release of Ag+ ions, continues to be a major challenge though which is addressed through this invention. The polymer enables the materials to bind to the matrices such as textile fibers very well and is important for the long-term claims. Also the curing at higher temperatures is not mandatory. Further, a photocatalyst is a material which absorbs light to bring it to higher energy level and provides such energy to a reacting substance to make a chemical reaction occur. Titanium dioxide treated materials have been shown to be effective against a wide range of microorganisms including protozoa algae, fungi, bacteria, and viruses. Besides, zinc oxide (ZnO) is one of the efficient photocatalyst materials. The optional complexors such as salts of EDTA also yields a “water softening” effect of the formulation in the case the fabric is rinsed with hard water. This enables the fabric antimicrobial to be evenly spread.

In an embodiment of the present invention, the invention relates to a disinfectant composition comprising at least one excipient, where the excipient includes but is not limited to polymer(s), surfactant(s), complexing agent(s), wetting agent(s), surface binder(s), vehicles, other additives and combinations thereof. In an embodiment the invention further discloses the combination of different photocatalysts and the methods of synthesis of the composition so that the end result is a potent and effective disinfectant.

In an embodiment of the present invention, the invention discloses an aqueous disinfectant and sanitizer composition for porous substrates comprising: 0% to 5% (wt/v) of at least one anti-microbial ceramic compound; carrier particles 0% to 30% (wt/v); binder polymer compounds 1% to 5% (wt/v); and excipient mix 0.1 to 50% (wt/v), further the excipient mix consists of a combination of cationic and anionic detergents.

In another embodiment of the present invention, the invention discloses a composition where at least one anti-microbial ceramic compound is selected from a group comprising of silver containing compounds, copper containing compounds, zinc containing compounds, platinum containing compounds, palladium containing compounds, magnesium containing compounds, molybdenum containing compounds and combinations thereof.

In yet another embodiment of the present invention, the invention discloses a composition containing at least one carrier particle, selected from a group of photocatalytic agents comprising of titanium compounds, zinc oxide, silica, and combinations thereof. Besides, the carrier particles provide the matrix for the anti-microbial compounds.

In still another embodiment of the present invention, the invention discloses a composition where at least one polymer is selected from a group comprising Polyacrylamide, poly(acrylamide-co-acrylic acid), Poly(vinyl alcohol) (PVA), poly vinyl pyrrolidone (PVP), carboxy methyl cellulose (CMC) and polyethylene oxide (PEO), acrylates and combinations thereof.

In a preferred embodiment of the present invention, the invention discloses a composition where at least one excipient is selected from a group comprising strong ionic detergents such as cetyltrimethylammonium bromide or chloride, sodium salt of cholic acid, sodium salt of deoxycholic acid, sodium salt of dioctyl sulfosuccinate, sodium salt of dodecyl sulphate and sodium salt of N-lauroylsarcosine and sodium lauryl ether sulphate (SLES) and combinations thereof.

In an exemplary embodiment of the present invention, the invention discloses a method for producing disinfectant/sanitizer composition for porous substrates comprising the steps: a. mixing 0% to 5% (wt/v) of at least one or mixture of antimicrobial ceramic compound selected from a group comprising compounds of silver, copper, zinc and combinations thereof with 0% to 30% (wt/v) of at least one carrier particle; b. grinding the mixture from step (a) into a fine form, followed by adding measured volume of water to the powder mix; c. adding 1% to 5% (wt/v) bio polymer to the solution obtained from step (b); d. adding at least one of the excipients followed by a second one in a ratio of almost 30 to 50% of the final composition; wherein the final volume is made up with water. This is a key inventive step of this disclosure. The resultant mixture is a viscous dense white colored liquid.

In another embodiment of the present invention, at least one carrier particle for supporting the antimicrobial metal compound on the surface of the carrier particle is selected from a group consisting of hydrous titanium oxide, titanium oxide, zinc oxide, silica and zeolites such as zeolites (microporous, aluminosilicate minerals), molecular sieves, and combinations thereof, but not limited to. Further, the Molecular sieves are good for absorbing gases.

In yet another embodiment of the present invention, the antimicrobial compound and the carrier salts are finely ground in an industrial grinder to ensure that the particle size is in the low micron range of −100 microns. In still another embodiment of the present invention, the excipient mix is a combination of cationic and anionic detergents in the ratio of 2:3 to 4:7. Further, when incorporated into the composition the excipient mix attenuates the suspension to a viscous and homogeneous solution which is very stable.

In a preferred embodiment of the present invention, the composition is in the form of a tablet or capsule containing the antimicrobial powder, or antimicrobial solutions in the form as aerosols, infusions, spray formulation, powder or powder spray, mist, drops, or one or more liquid formulations or spray dried to generate a powdered form, and combinations thereof, where the cold spraying or spray drying technique is used for making powder formulation.

In another preferred embodiment of the present invention, the invention provides an antimicrobial textile or fabric impregnated with the disinfectant composition, wherein the step of application includes spraying, coating, pouring and the like. The invention further provides an antimicrobial material made of polymer or wood or rubber base which is impregnated with the composition described herein above in the manufacturing stage itself. Besides, there is provided air and water filters impregnated with the disinfectant composition that aids in the removal of volatile organic compounds (VOCs), thereby having great potential applications to contaminant control in indoor environments such as residences, office buildings, factories. The application step involves techniques such as padding, exhaust and other appropriate methods.

Another major feature of the present formulation is the negative ion effect. The most important benefit of negative ions is that they clear the air of airborne allergies such as pollen, mold spores, bacteria and viruses. Besides they also clear the air of dust, pet dander and cigarette smoke. Negative ions perform this function by attaching themselves to positively charged particles in large numbers and negatively charging those particles. As a result, these viruses, bacteria and pollen spores become too heavy to remain airborne and are thus prevented from entering your breathing passage where they can make you fall sick. In other words, negative ions form a protective circle. Some versions of the present formulation can be sprayed on and bind to the surfaces simply by drying.

### EXAMPLES

Example 1: The silver chloride, poly vinyl pyrrolidone, zinc oxide and the titanium dioxide were finely ground in an industrial grinder to ensure that the particle size was in the low micron range of −100 microns. The strong ionic detergents mentioned above (not limited to the list above but notably with low cmc values) were used up to 50% of the weight of the formulation, added in a sequential manner and mixed thoroughly The thick viscous formulation that finally resulted did not separate out into solids and supernatant even on dilution up to 1% in water.

Example 2: In one embodiment, the disinfectant composition comprising silver chloride 0.1 to 5% (wt/v); zinc oxide 0.1 to 5% (wt/v); titanium dioxide 0.1 to 5% (wt/v); at least one polymer 0.1 to 5% (wt/v); and a mixture of a strong anionic detergent such as the dioctyl sodium sulfosuccinate and cetrimonium chloride (25%+15%) in an water was formulated and antibacterial activity of the said composition when added into the FACE MASK, was studied when tested using BS EN ISO 20743 against S. aureus. In the study, the absorption method was used for the determination of antibacterial activity of textile products to BS EN ISO 20743 against S. aureus. The test sample (0.4 g) were inoculated with 0.2 ml of the relevant culture containing a known number of organisms (1×105-3×105 cfu/ml) in Tryptone Soya Broth (TSB) (1/20 Dilution). The product was tested in triplicate against each organism. The non-adhesive material was inoculated. Three test samples were sampled immediately and 3 samples were incubated for 2 h 37±2° C. After incubation (or immediately) the samples were rinsed with 20 ml of neutralizer (DE broth) and stomached. The extracts were serially diluted and the bacteria enumerated using pour plate method with Tryptone Soya Agar (TSA). The plates were incubated at 37±2° C. for 40-48 hrs and any resultant colonies counted. The control used was a non-woven cloth of the same weight as the test sample. Each control was prepared by inoculating the control samples with broth culture and incubating as described above. The controls were tested in triplicate. 3 samples were extracted immediately after inoculation, as well as at 2 hrs. The extracts were treated as described above the resultant counted (Table 1). The mean for the triplicate samples was then calculated and the antibacterial activity (A) was calculated compared to the control at time t using the formulae

A=(Log C_{T}−Log C₀)−(Log T_{T}−Log T₀) (1)

where,
A=antibacterial activity value
Log T_{T}=common log of arithmetic average of the number of bacteria from the 3 treated specimens after incubation
Log T₀=common log of arithmetic average of the number of bacteria from the 3 treated specimens immediately after incubation.
Log C_{T}=common log of arithmetic average of the number of bacteria from the 3 control specimens after incubation
Log C₀=common log of arithmetic average of the number of bacteria from the 3 control specimens immediately after incubation

TABLE 1
Results

| | S. aureus | | | |
|---|---|---|---|---|
| | Control | Treated | Control | |
| | Sample | Sample | Sample | Treated Sample |
| Sample No. | T = 0 | T = 0 hrs | T = 2 hrs | T = 2 hrs |
| Mean (cfu/ml) | 1.2 × 10⁵ | 1.1 × 10⁵ | 1.1 × 10⁶ | 4.8 × 10⁴ |
| Log value | 5.08 | 5.04 | 6.04 | 4.68 |
| Antibacterial | — | — | — | 1.36 |
| Activity | | | | |
| % Reduction | — | — | — | 99.56% |

Note: Initial inoculum was 0.2 ml of 2.4×105 cfu/ml

Example 3: In another embodiment, the disinfectant composition comprises: silver salt 0.1 to 5% (wt/v); zinc oxide 0.1 to 5% (wt/v); titanium dioxide 0.1 to 5% (wt/v); silicon dioxide 0.1 to 5% (wt/v); magnesium oxide, where the silicon dioxide imparts a temperature control “cool” effect to the fabric; at least one polymer 0.1 to 5% (wt/v); and a mixture of a strong anionic detergent such as the dioctyl sodium sulfosuccinate and cetrimonium chloride. One of the mechanisms by which the silica works is to “wick” away the perspiration from the wearer of the fabric giving a cooling effect.

Example 4: In one embodiment, the disinfectant composition comprises the salts as silver compounds in an amount of 0.1 to 2 wt. %; cationic surfactants such as CTAC of 0.1 to 10 wt. %; Poly vinyl pyrrolidone in an amount of 0.1 to 2 wt. %; a non-ionic ionic detergent of the polysorbate kind such as the Tween 20 in an amount of 0 to 0.5 wt. %; alcohol for quick drying. Hydrophobic elements such as Triethoxy-1H,1H,2H,2H-tridecafluoro-n-octylsilane were added as required if the hydrophobicity was to be imparted. Fragrances were added in certain combinations. The resultant formulation was an excellent “spray on fabric product” that could be a unique offering as it deodorizes and disinfects clothes and could minimize the washing cycles. It could also be used in the normal way with washing, padding and other applications.

Example 5: In another embodiment, the disinfectant composition comprising, a cationic surfactant such as the cetrimonium chloride 5 to 10%, silver salt 100-500 mg; and Poly vinyl pyrrolidone 0.1 to 2 wt. % was mixed in with a little isopropanol (up to 10%) and fragrance, rest of the volume was made up with water. This was also an excellent spray on or dip antimicrobial for porous substances.

Example 6. Experiencing headache, uneasiness or sudden nausea in an overcrowded room is a common problem, where sometimes even in an air-conditioned room these conditions might be experienced. The reason for these inconvenient situations is the lack of negative ions in the room. It's been reported that, negative ions are beneficial for the human body while positive ions are harmful, where the highest concentrations of negative ions is present in natural, clean air. Ions are invisible charged particles in the air—either molecules or atoms, which bear an electric charge, with some particles being positively charged and some negatively charged. The positive ions are molecules that have lost one or more electrons whereas negative ions are actually oxygen atoms with extra-negatively-charged electrons. Thereby, negative ions are abundant in nature, especially around waterfalls, on the ocean surf, at the beach, after a storm and widespread in mountains and forests.

Negative ions are present in the air we breathe in, as well as present in our bodies. The degree to which negative ions contribute to overall well-being and health is scientifically proven as they neutralize free radicals, revitalize cell metabolism, enhance immune function, purify the blood, balance the autonomic nervous system, promoting deep sleep and healthy digestion. On the other hand, in polluted cities, crowded areas and in confined spaces such as offices, industrial areas, schools and cars, highest concentration of unhealthy positive ions is observed. To study this aspect, the disinfectant additive composition was added to the paint samples and the effect on the count of negative ions was recorded. The paint sample was prepared with different percentages of the negative ion formulations. In the said formulation the special ceramic materials powder forms (oxides) that generate the natural negative ions were mixed with the surfactants and water to form the pastes/slurries. These were mixed in various proportions with the water-based paints, where both the cationic and anionic surfactants as described earlier helped to keep the particles in perfect suspension (Table 2).

TABLE 2
Results for the negative ions are as under

| Date & | First | Second | Third | Fourth | Fifth | one week after |
|---|---|---|---|---|---|---|
| Sample | day | day | day | day | day | fifth day |
| 1% in V/V | 23 | 19 | 27 | 31 | 27 | 31 |
| 3% in V/V | 47 | 46 | 45 | 42 | 51 | 49 |
| 5% in V/V | 90 | 91 | 93 | 89 | 95 | 91 |
| 10% in V/V | 358 | 356 | 349 | 367 | 389 | 351 |
| 15% in V/V | 805 | 900 | 1001 | 834 | 888 | 942 |

The above numbers are for the counts of negative ions. The negative ions generally require a dry surface for good effect. The negative ions count was almost negligible on day of application i.e., day 0 and it significantly increased from day 1 onwards. The counts remained almost constant over a period of one week. The negative ion concentration depends a lot on the air inflow on the sample and the amount of air that is impinging on the sample.

Example 7: To study the effect of formulations on carbon dioxide and VOC lowering surfaces (paints, fabrics), the materials described above for the elimination of CO2 along with various combinations were also used for coating materials of masks such as that of polypropylene materials so that a chemical reaction such as chemisorptions which blocked the incoming gases and vapours could take place. Along with the activated carbon the materials include amines, ammonium hydroxide, oxidizing agents such as permanganates apart from the combinations given for in the section above. The composition of the additive for the CO2 filters is generally 10 to 30% the oxides of calcium and magnesium, 10 to 30% zeolites, and some of the binders and surfactants as described earlier. Besides, 20 to 50% highly absorbing activated carbon may also be added to the composition to enhance the absorption of volatile compounds. CO2 released into the atmosphere was recorded using the CO2 detector, and it was observed that levels of CO2 release from the treated filters was less as compared to the control filters. Thus, confirming that CO2 filter lowers the amount of CO2 release in the relative time (Table 3).

TABLE 3
CO2 release (ppm) detected in the atmosphere from treated and control filters

| Time | CO2 release from treated | |
|---|---|---|
| (seconds) | filters | CO2 release from the control filters |
| 0 | 4174 | 4022 |
| 10 | 2499 | 3400 |
| 20 | 2380 | 3093 |
| 30 | 2286 | 2953 |
| 40 | 2053 | 2825 |
| 50 | 2053 | 2621 |
| 60 | 1932 | 2383 |
| 70 | 1758 | 2063 |
| 80 | 1606 | 2029 |
| 90 | 1591 | 2022 |
| 100 | 1565 | 1989 |
| 110 | 1555 | 1965 |
| 120 | 1555 | 1947 |

Example 8: Experimental Culturing of Drosophila Melanogaster: Drosophila is a genus of small flies, belonging to the family Drosophilidae, whose members are often called “fruit flies”. The basic genetic similarities are shared with humans. Drosophila cultures are ought to be kept in room temperature where the temperature does not range below 20 degrees Celsius or above 25 degrees Celsius. They are cultured on fermenting medium which contains banana, vinegar and yeast extract. Experiments were carried out in such a way to look upon what changes and effects were going to be there on the flies when they were cultured with negative ion sample made during the study. It was observed that in the initial stage in the control sample, growth was at low level and after couple of 2 days prominent growth was seen. In the sample medium, coated with negative ion paint, growth took place slowly but after a week growth was better. Besides, the movement of larval form was in the upward direction. These results confirmed that the treatment with the said composition increased the amount of negative ions in the air and in turn increasing the growth of flies.

Technical Advance: It is commonly known that cationic and anionic surfactants cannot be mixed without the risk of precipitation or instability. However, not only is it possible to combine cationic and anionic surfactants, but also that this combination can present synergistic properties. The methodology of making this concoction is one of the important inventive steps covered in this patent. However, cationic and anionic mixed surfactants in an aqueous medium show the strongest synergisms in the formation of mixed micelle and surface tension reduction of the solution. The mixed surfactants solution can demonstrate lower surface tension with higher critical aggregation concentrations (CACs) which is important to keep the mixed phase in suspension. The mix results in stronger hydrophobic-hydrophobic interactions and intermolecular force increasing the overall viscosity of the composition. The composition thus being an even suspension is a stable and scalable composition. Besides, as part of air and water filters, the additive aids in the removal of volatile organic compounds (VOCs); thereby providing great potential applications for contaminant control in indoor environments such as residences, office buildings, factories. Further on the same lines as described above, there are single gas filters; which protect against one type of gas or vapor and there are also multiple gas filters, such as ABEK filters. These protect against several types of gases, organic and inorganic vapours, sulphur dioxide and ammonia. An ABEK filter absorbs dangerous gases and vapours, enabling the user to breathe safely. The ABEK filter was made with similar compositions and also contained copper oxides and molybdenum oxides besides the activated carbon granules.

In accordance with advantages of the present invention as compared with the existing formulations, the present invention is to provide a big change in the field of antimicrobial additives for porous surfaces. The composition, with low toxicity and non-sensitizing nature, is effective at very low ppm addition levels. The microbial composition is to be added as a single and last component, without the need of any binders, thus not interfering with the characteristics of future compositions.

The formulation of the present invention has several unique mechanisms of action: When silver ions are in solution, molecules associate with the charged surface to establish multiple layers of charges that stabilizes the particles and prevents aggregation. Antibacterial activity of formulation is usually attributed to electrostatic interactions between cations and the negatively charged membrane surface of microbe and/or to other interactions between the cations and the microbe's RNA/DNA proteins. E.g., the composition of the present invention applied on or impregnated into the fabrics, the active ingredient such as silver, titania, zinc oxide are photosensitizers which generates singlet oxygen when exposed to light. The singlet oxygen oxidizes the microbe's protein and lipid, and consequently leads to the death of microbes. The reactive ion species that are generated on the surface also have antimicrobial action.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

Although embodiments for the present invention have been described in language specific to structural features, it is to be understood that the present invention is not necessarily limited to the specific features described. Rather, the specific features and methods are disclosed as embodiments for the present invention. Numerous modifications and adaptations of the system/component of the present invention will be apparent to those skilled in the art, and thus it is intended by the appended claims to cover all such modifications and adaptations which fall within the scope of the present invention.

Advantages:
The technology of the present invention imparts anti-microbial and self cleaning ability to home laundry, for apparel and bed-linen, sanitation, cosmetics, antibiotic daily necessities and medical products.
Titania and zinc oxide photocatalysts: The photo-catalyst agent has following two tangible advantages: advantage one is that antibiotic efficiency is high and durable. Second, TiO 2 can not only suppress bacterial reproduction, but exert a non-contact biocidal action.
The anti microbial treated textiles provide barrier protection to the wearer and prohibit complete growth of bacteria, smells, odors etc.
The composition potentially eliminates virus, bacteria and mould from the surface and the fabric remains 99.99% virus free even after 30 washes (@40° C., 30 min). This in turn drastically reduces the washing cost, thus a cost effective technology.
The technology provides a light and heat stable, broad-spectrum composition which is eco-friendly, and safe on skin.
It is based on inorganic skin-safe technology.
The composition is applicable for all fiber types and also suitable for synthetic fibers including textiles having direct skin contact. Examples: Apparel Home Textile Bedding Intimate Shirts Trousers Suits Knitwear Denims Active Wear Work & Outer wear Socks Ties/Accessories Upholstery Curtains Bath Towels Kitchen Towels Table Cloths Wipes Bath Robes Napkins Mattresses Pillow Covers Duvets Bed Sheets.

1. An aqueous disinfectant and sanitizer composition for porous substrates, the composition comprising:
water;
an anti-microbial compound, wherein the anti-microbial compound is up to 5 percent weight per volume of the composition (% wt/v);
carrier particles, wherein the carrier particles provide a ceramic matrix for the anti-microbial compound, wherein the carrier particles are up to 30% wt/v;
a binder polymer, wherein the binder polymer up to 5% wt/v; and
an excipient mix, wherein the excipient mix is up to 50% wt/v.

2. The composition of claim 1, wherein the anti-microbial compound is at least one of, a silver compound, a copper compound, a zinc compound, a platinum compound, a palladium compound, a magnesium compound, and a molybdenum compound.

3. The composition of claim 1, wherein the carrier particles are photocatalytic agents including at least one of titanium compounds, zinc oxide, and silica.

4. The composition of claim 1, wherein the binder polymer is at least one of polyacrylamide, poly(acrylamide-co-acrylic acid), polyvinyl alcohol (PVA), polyvinyl pyrrolidone (PVP), carboxy methyl cellulose (CMC), polyethylene oxide (PEO), and acrylates.

5. The composition of claim 1, wherein the excipient mix is cationic and anionic detergents.

6. The composition of claim 5, wherein the excipient mix includes at least one of cetyltrimethylammonium bromide, chloride, sodium salt of cholic acid, sodium salt of deoxycholic acid, sodium salt of dioctyl sulfosuccinate, sodium salt of dodecyl sulphate, sodium salt of N-lauroylsarcosine, and sodium lauryl ether sulphate (SLES).

7. The composition of claim 5, wherein the excipient mix has a ratio of cationic to anionic detergents of 4:7 to 2:3.

8. The composition of claim 1, wherein,
the anti-microbial compound is at least one of, a silver compound, a copper compound, a zinc compound, a platinum compound, a palladium compound, a magnesium compound, and a molybdenum compound,
the carrier particles are photocatalytic agents, and
the excipient mix includes a strong ionic detergent.

9. The composition of claim 8, wherein the anti-microbial compound is a silver compound, wherein the carrier particles include silicon dioxide, and wherein the strong ionic detergent is a strong anionic detergent.

10. A method for producing an aqueous disinfectant and sanitizer composition for porous substrates, the method comprising:
grinding an anti-microbial compound and carrier particles into a combined powder mix, wherein the carrier particles provide a ceramic matrix for the anti-microbial compound, wherein the anti-microbial compound is up to 5 percent weight per volume of the composition produced (% wt/v), and wherein the carrier particles are up to 30% wt/v;
adding water to the powder mix to form an aqueous solution;
adding a binder polymer to the aqueous solution, wherein the binder polymer is 1 to 5% wt/v; and
adding an excipient mix to the aqueous solution, wherein the excipient mix is 0.1 to 50% wt/v.

11. The method of claim 10, wherein the anti-microbial compound is at least one of, a silver compound, a copper compound, a zinc compound, a platinum compound, a palladium compound, a magnesium compound, and a molybdenum compound.

12. The method of claim 10, wherein the carrier particles are at least one of, hydrous titanium oxide, titanium oxide, zinc oxide, silica, zeolites, and molecular sieves.

13. The method of claim 10, wherein the grinding uses a grinder that reduces particle size of the combined powder mix to approximately 100 microns or less.

14. The method of claim 10, wherein the binder polymer is at least one of polyacrylamide, poly(acrylamide-co-acrylic acid), polyvinyl alcohol (PVA), polyvinyl pyrrolidone (PVP), carboxy methyl cellulose (CMC), polyethylene oxide (PEO), and acrylates.

15. The method of claim 10, wherein the excipient mix is cationic and anionic detergents, and wherein the excipient mix includes at least one of cetyltrimethylammonium bromide, chloride, sodium salt of cholic acid, sodium salt of deoxycholic acid, sodium salt of dioctyl sulfosuccinate, sodium salt of dodecyl sulphate, sodium salt of N-lauroylsarcosine, and sodium lauryl ether sulphate (SLES).

16. The method of claim 15, wherein the excipient mix has a ratio of cationic to anionic detergents of 4:7 to 2:3.

17. The method of claim 10, further comprising:
forming the composition into a tablet, a capsule, an aerosol, an infusion, a spray, a mist, or a drop.

18. The method of claim 10, wherein,
the anti-microbial compound is at least one of, a silver compound, a copper compound, a zinc compound, a platinum compound, a palladium compound, a magnesium compound, and a molybdenum compound,
the carrier particles are photocatalytic agents forming a matrix for the anti-microbial compound, and
the excipient mix includes a strong ionic detergent.

19. The method of claim 10, wherein the anti-microbial compound is a silver compound, wherein the carrier particles include a silica, and wherein the strong ionic detergent is a strong anionic detergent.

20. The method of claim 19, wherein the silver compound is a silver salt, wherein the silica is silicon dioxide, and wherein the strong anionic detergent includes at least one of dioctyl sodium sulfosuccinate and cetrimonium chloride.
